(19) United States
(12) Patent Application Publication
(10) Pub. No.: US 2023/0384344 A1
(43) Pub. Date: Nov. 30, 2023

(54) Inertial Measurement Device

(71) Applicant: SEIKO EPSON CORPORATION, Tokyo (JP)

(72) Inventor: Kenta SATO, Shiojiri (JP)

(21) Appl. No.: 18/324,194

(22) Filed: May 26, 2023

(30) Foreign Application Priority Data
May 30, 2022 (JP) 2022-087477

(51) Int. Cl. G01P 15/18; G01P 15/097; G01P 1/02; G01P 1/00

(52) U.S. Cl. CPC G01P 15/18; G01P 15/097; G01P 1/023; G01P 1/006

(57) ABSTRACT

An inertial measurement device includes: a board; a first inertial sensor disposed on one surface of the board and having a first detection axis along the board; a second inertial sensor disposed on the one surface of the board and having a second detection axis defined in a direction opposite to the first detection axis; and a processing circuit configured to generate a differential signal between an output signal of the first inertial sensor and an output signal of the second inertial sensor.

The present application is based on, and claims priority from JP Application Serial Number 2022-087477, filed May 30, 2022, the disclosure of which is hereby incorporated by reference herein in its entirety.

### BACKGROUND

### 1. Technical Field

The present disclosure relates to an inertial measurement device.

### 2. Related Art

WO2015/145489 discloses a technique of obtaining a differential value between detection values of a first sensor and a second sensor that are disposed to face each other with a board interposed therebetween. Noises generated in the same phase in the detection values of the first sensor and the second sensor can be canceled out by obtaining the differential value.

In the technique disclosed in WO2015/145489, since the first sensor and the second sensor are disposed to face each other with the board interposed therebetween, stresses from the board are generated in the first sensor and the second sensor from directions opposite to each other. For example, when the board is warped due to thermal expansion of the board or an external force, a compressive stress from the board is applied to one of the first sensor and the second sensor, and a tensile stress from the board is applied to the other sensor. Since the stress from the board distorts, via a package of the sensor, a sensor element or the like accommodated in the package, detection accuracy of the sensor decreases due to a noise caused by the stress from the board. In the technique disclosed in WO2015/145489, since the stresses from the board are generated in the first sensor and the second sensor from directions opposite to each other, it is difficult to cancel out the noise caused by the stress from the board.

### SUMMARY

An inertial measurement device includes: a board; a first inertial sensor disposed on one surface of the board and having a first detection axis along the board; a second inertial sensor disposed on the one surface and having a second detection axis defined in a direction opposite to the first detection axis; and a processing circuit configured to generate a differential signal between an output signal of the first inertial sensor and an output signal of the second inertial sensor.

### BRIEF DESCRIPTION OF THE DRAWINGS

FIG. 1 is a perspective view of an inertial measurement device according to a first embodiment.

FIG. 2 is an exploded perspective view of the inertial measurement device.

FIG. 3 is a cross-sectional view of the inertial measurement device.

FIG. 4 is a plan view of a container.

FIG. 5 is a perspective view of a circuit board.

FIG. 6 is a perspective view of a sensor element.

FIG. 7 is a cross-sectional view of an inertial sensor using the sensor element.

FIG. 8 is a plan view of a circuit board provided in an inertial measurement device according to a second embodiment.

FIG. 9 is a perspective view of a circuit board provided in an inertial measurement device according to a third embodiment.

FIG. 10 is a perspective view of a circuit board provided in an inertial measurement device according to a fourth embodiment.

### DESCRIPTION OF EXEMPLARY EMBODIMENTS

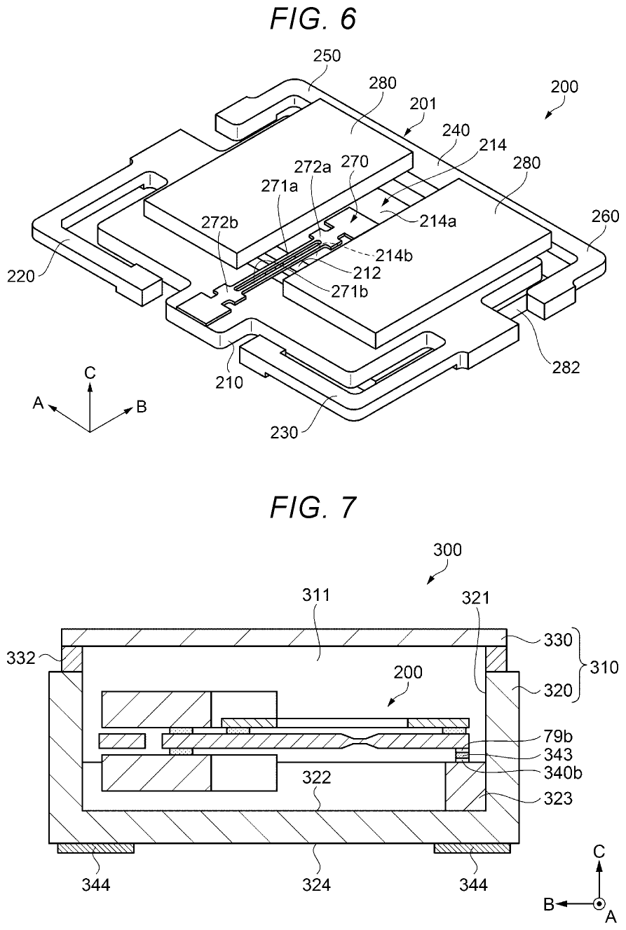

Hereinafter, embodiments of the present disclosure will be described with reference to the drawings. For convenience of description, in each of the drawings except for FIGS. 6 and 7, an X-axis, a Y-axis, and a Z-axis are shown as three axes orthogonal to each other. A coordinate system including the X-axis, the Y-axis, and the Z-axis is a reference coordinate system for describing an inertial measurement device according to the present disclosure. In FIGS. 6 and 7, an A-axis, a B-axis, and a C-axis are shown as three axes orthogonal to each other. A coordinate system including the A-axis, the B-axis, and the C-axis is a local coordinate system for describing an inertial sensor according to the present disclosure.

A direction along the X-axis is also referred to as an “X-axis direction”, a direction along the Y-axis is also referred to as a “Y-axis direction”, a direction along the Z-axis is also referred to as a “Z-axis direction”, a direction along the A-axis is also referred to as an “A-axis direction”, a direction along the B-axis is also referred to as a “B-axis direction”, and a direction along the C-axis is also referred to as a “C-axis direction”. In addition, for example, a Y direction refers to a direction toward an arrow tip side along the Y-axis, and a −Y direction refers to a direction toward an arrow base side along the Y-axis. The Y-axis direction refers to both the Y direction and the −Y direction. In addition, a plan view seen from a Z direction may be simply referred to as a “plan view”.

### 1. First Embodiment

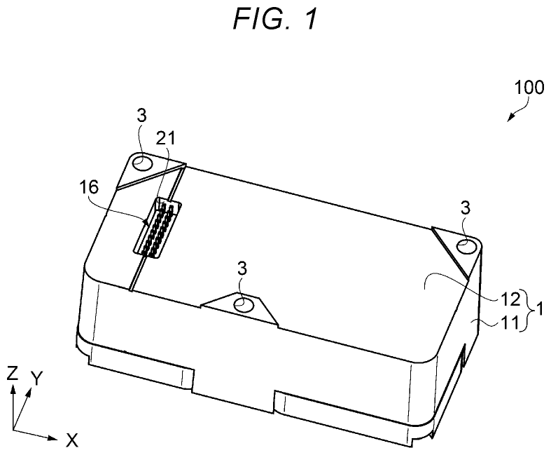

An inertial measurement device 100 according to a first embodiment will be described with reference to FIGS. 1 to 5. The inertial measurement device 100 is a measurement device that measures a physical quantity by using inertia. In the embodiment, the inertial measurement device 100 measures an acceleration in the Y-axis direction as an example of the physical quantity. However, the physical quantity measured by the inertial measurement device 100 is not limited thereto.

As shown in FIG. 1, an outer shape of the inertial measurement device 100 is generally a rectangular parallelepiped shape having sides along the X-axis, the Y-axis, and the Z-axis, respectively. The inertial measurement device 100 has a substantially rectangular shape defined by a long side along the X-axis and a short side along the Y-axis in the plan view. The inertial measurement device 100 includes three screw holes 3 formed in the vicinity of both end portions of one long side and the vicinity of a center portion of the other long side in the plan view. By passing fixing screws through the respective screw holes 3, the inertial measurement device 100 can be fixed to an attachment surface of an attachment target body. The inertial measurement device 100 is used in a state of being fixed to the attachment target body which is a vibration measurement target. The attachment target body is, for example, a structure such as a building or a bridge, or a moving body such as an automobile, a drone, or a robot.

The inertial measurement device 100 includes an opening portion 21 provided in a surface facing the Z direction. A connector 16 of a plug type is disposed inside the opening portion 21. The connector 16 includes a plurality of pins disposed in two rows, and the plurality of pins are arranged in the Y direction in each row. A connector (not shown) of a socket type is coupled to the connector 16. Through the connector 16, transmission and reception of an electrical signal such as a drive voltage of the inertial measurement device 100 or a measured value output from the inertial measurement device 100 are performed between the inertial measurement device 100 and an external device (not shown).

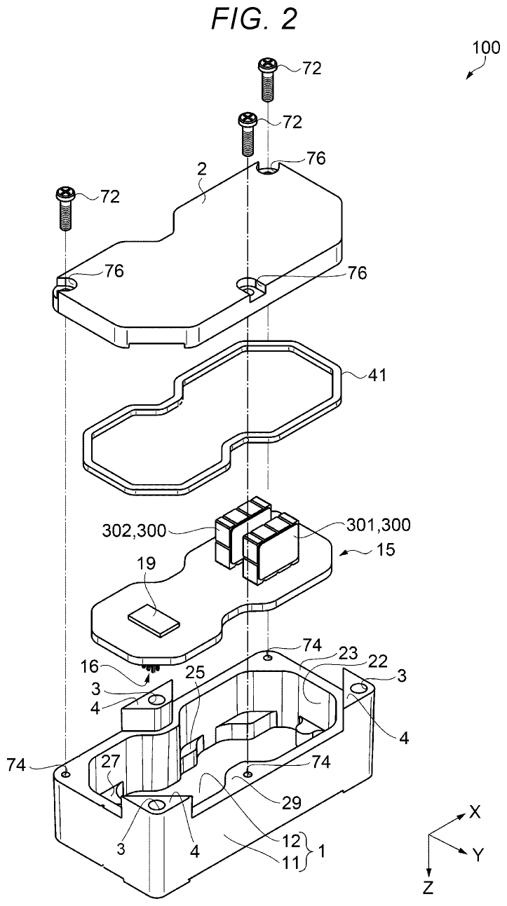

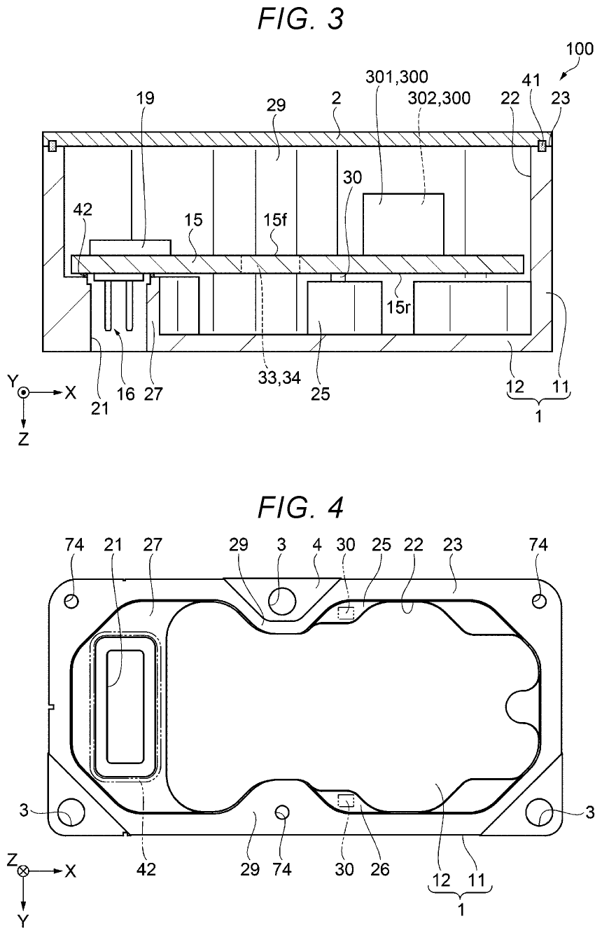

As shown in FIGS. 2 and 3, the inertial measurement device 100 includes a container 1, a lid portion 2, a seal member 41, a circuit board 15, and the like. The circuit board 15 is a board in the present disclosure. Specifically, the circuit board 15 is attached to an inner side of the container 1 via fixing members 30 and 42. The lid portion 2 covers an opening of the container 1 via the seal member 41. The lid portion 2 is fixed, by a screw 72 inserted into a through hole 76 provided in the lid portion 2 and a female screw 74 provided in the container 1, to the container 1 via the seal member 41.

The container 1 accommodates the circuit board 15. The container 1 has a box shape opened toward a −Z direction. An outer shape of the container 1 is substantially a rectangular parallelepiped shape and forms a part of the outer shape of the inertial measurement device 100. A metal such as aluminum can be adopted as a material for the container 1.

The container 1 includes a flat plate-shaped bottom portion 12 and a frame-shaped side wall 11 erected in the −Z direction from an outer peripheral portion of the bottom portion 12. Inside of the container 1 can be defined as a space surrounded by the bottom portion 12 and the side wall 11. The circuit board 15 is disposed such that an outer edge thereof extends along an inner surface 22 of the side wall 11. The lid portion 2 is fixed to an opening surface 23 so as to cover the opening of the container 1. The opening surface 23 coincides with an end surface of the side wall 11 on which the lid portion 2 is placed. On the opening surface 23, three fixed protruding portions 4 are erected in the vicinity of both end portions of one long side and the vicinity of a center portion of the other long side of the container 1 in the plan view. In addition, in the opening surface 23, three female screws 74 are provided in the vicinity of a center of the one long side and the vicinity of both end portions of the other long side of the container 1 in the plan view. The screw hole 3 is formed in each of the fixed protruding portions 4.

In addition, as shown in FIGS. 3 and 4, the side wall 11 includes two protruding portions 29 each protruding inward in a ridge shape from the bottom portion 12 to the opening surface 23. The two protruding portions 29 are located in the vicinity of the center portion of the one long side and the vicinity of the center portion of the other long side of the container 1 in the plan view. The two protruding portions 29 correspond to constricted portions 33 and 34 of the circuit board 15 to be described later.

In addition, the container 1 includes a first pedestal 27 and second pedestals 25 and 26 protruding, in a stepped shape higher by one step, from the bottom portion 12 toward the opening surface 23. The first pedestal 27 is provided in a region including a region in which the connector 16 attached to the circuit board 15 is disposed in the plan view. The container 1 includes the opening portion 21 provided in the first pedestal 27 in the plan view. The opening portion 21 penetrates the inside and the outside of the container 1. The connector 16 is inserted into the opening portion 21.

The second pedestals 25 and 26 are located on a side opposite to the first pedestal 27 with respect to the two protruding portions 29. The first pedestal 27 and the second pedestals 25 and 26 function as pedestals for fixing the circuit board 15 to the container 1.

A planar shape of the outer shape of the container 1 is not limited to the rectangular shape and may be a polygonal shape such as a square shape, a hexagonal shape, or an octagonal shape. In addition, a corner of an apex portion of the polygon may be chamfered, or any one of sides of the polygon may have a curved planar shape. In addition, a planar shape of inside of the container 1 is not limited to the shape described above and may be another shape. In addition, planar shapes of the outer shape and the inside of the container 1 may be similar or may not be similar.

The circuit board 15 that serves as the board is a multilayer board in which a plurality of through holes and the like are formed. In the embodiment, a glass epoxy board is used as the circuit board 15. The circuit board 15 is not limited to the glass epoxy board, and a composite board or a ceramic board may be used.

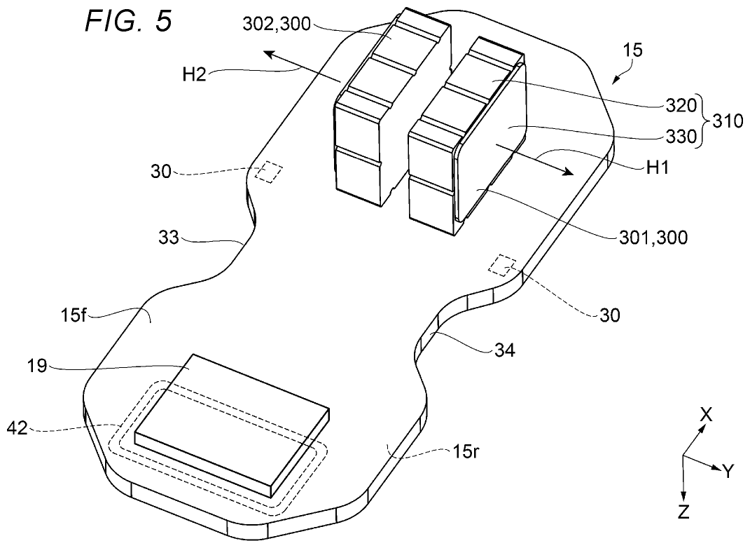

As shown in FIGS. 3 and 5, the circuit board 15 has a flat plate shape having a first surface 15f and a second surface 15r along an X-Y plane orthogonal to the Z-axis as main surfaces. The first surface 15f and the second surface 15r have a front and back relationship with each other. The first surface 15f is a surface on the opening side of the container 1, and the second surface 15r is a surface on the bottom portion 12 side.

The circuit board 15 includes the constricted portions 33 and 34 at a center thereof in the X-axis direction in the plan view. The constricted portions 33 and 34 are constricted toward the center of the circuit board 15 on both sides in the Y-axis direction of the circuit board 15 in the plan view. The circuit board 15 is inserted into an internal space of the container 1 with the second surface 15r facing the first pedestal 27 and the second pedestals 25 and 26. The circuit board 15 is fixed to the container 1 by being supported by the first pedestal 27 and the second pedestals 25 and 26.

Two inertial sensors 300, a processing circuit 19, other electronic components (not shown), and the like are disposed on the first surface 15f of the circuit board 15. The connector 16 is disposed on the second surface 15r of the circuit board 15. The processing circuit 19, the two inertial sensors 300, and the connector 16 are electrically coupled to each other via a wiring (not shown). Although not shown, the circuit board 15 may be provided with another wiring or another terminal electrode. In addition, although the processing circuit 19 is disposed on the first surface 15f of the circuit board 15 in the embodiment, the processing circuit 19 may be disposed on the second surface 15r.

The inertial sensor 300 is a sensor that detects a physical quantity by using inertia. In the embodiment, the inertial sensor 300 is an acceleration sensor capable of detecting an acceleration in one axial direction as the physical quantity. However, the inertial sensor 300 is not limited to the acceleration sensor and may be a sensor capable of detecting information related to inertia by a well-known detection method. For example, the inertial sensor 300 may be an angular velocity sensor. In addition, a sensor capable of detecting a physical quantity in multiaxial directions of 2 or more axes may be used. A configuration of the inertial sensor 300 used in the embodiment will be described later.

Among the two inertial sensors 300 disposed on the first surface 15f of the circuit board 15, one is a first inertial sensor 301, and the other is a second inertial sensor 302. The first inertial sensor 301 and the second inertial sensor 302 have the same configuration. The first inertial sensor 301 detects an acceleration on a first detection axis H1. The second inertial sensor 302 detects an acceleration on a second detection axis H2. The second detection axis H2 of the second inertial sensor 302 is defined in a direction opposite to the first detection axis H1 of the first inertial sensor 301. That is, a positive direction of one of the first detection axis H1 and the second detection axis H2 is the same as a negative direction of the other axis. Therefore, a detection value of the second inertial sensor 302 is in opposite phase to a detection value of the first inertial sensor 301.

In the embodiment, the first detection axis H1 of the first inertial sensor 301 and the second detection axis H2 of the second inertial sensor 302 are detection axes along the Y-axis. Specifically, the first detection axis H1 of the first inertial sensor 301 is a detection axis whose positive direction is the Y direction, and the second detection axis H2 of the second inertial sensor 302 is a detection axis whose positive direction is the −Y direction. More specifically, the first detection axis H1 is a detection axis whose positive direction is the Y direction and whose negative direction is the −Y direction. The second detection axis H2 is a detection axis whose positive direction is the −Y direction and whose negative direction is the Y direction. Accordingly, for example, the positive direction of the first detection axis H1 and the negative direction of the second detection axis H2 are the same.

The first inertial sensor 301 detects an acceleration on the first detection axis H1 and sequentially outputs an output signal corresponding to a detection value to the processing circuit 19. The second inertial sensor 302 detects an acceleration on the second detection axis H2 and sequentially outputs an output signal corresponding to a detection value to the processing circuit 19.

The processing circuit 19 controls each unit necessary for operating the inertial measurement device 100. The processing circuit 19 is, for example, a micro-controller unit (MCU), and includes a storage medium such as a non-volatile memory, an A/D converter, and the like. The storage medium stores a program and the like necessary for detecting an acceleration by the inertial sensor 300 and outputting the acceleration to an external device.

In addition, the processing circuit 19 calculates a differential value that is a difference between a detection value of one inertial sensor 300 of the two inertial sensors 300 and a detection value of the other inertial sensor 300. By calculating the differential value, it is possible to amplify the detection value while canceling out in-phase error factors. Examples of the in-phase error factors include electrical noises and temperature characteristics of the inertial sensor 300.

Specifically, the processing circuit 19 generates, based on the output signal as the detection value of the first inertial sensor 301 and the output signal as the detection value of the second inertial sensor 302, a differential signal as a differential value that is a difference between the detection value of the first inertial sensor 301 and the detection value of the second inertial sensor 302. The differential signal generated by the processing circuit 19 is output to an external device coupled to the inertial measurement device 100 via the connector 16. In the embodiment, the differential signal output from the inertial measurement device 100 corresponds to a measurement value of an acceleration in the Y-axis direction measured by the inertial measurement device 100.

Here, an example of a configuration of the inertial sensor 300 will be described with reference to FIGS. 6 and 7. In the embodiment, the inertial sensor 300 is a frequency-variable type acceleration sensor. The frequency-variable type acceleration sensor includes a sensor element including a vibration element. The sensor element is configured to change a force applied to the vibration element according to an acceleration. When the force applied to the vibration element changes, a resonance frequency of the vibration element changes according to the force applied to the vibration element. In this way, by detecting the resonance frequency of the vibration element according to the acceleration, the frequency-variable type acceleration sensor can detect the acceleration.

As shown in FIG. 7, the inertial sensor 300 includes a sensor element 200 and a package 310. An accommodation space 311 that accommodates the sensor element 200 is defined in the package 310. In the embodiment, first, the sensor element 200 will be described with reference to FIG. 6, and then the inertial sensor 300 using the sensor element 200 will be described with reference to FIG. 7.

As shown in FIG. 6, the sensor element 200 includes a board structure 201 including a base portion 210 and the like, a vibration element 270 that is supported by the board structure 201 and detects an acceleration, and mass portions 280 and 282.

The board structure 201 has a flat plate shape having two main surfaces along an A-B plane orthogonal to the C-axis. The board structure 201 includes the base portion 210, a movable portion 214, a coupling portion 240, and four support portions coupled to the base portion 210. The four support portions are a first support portion 220, a second support portion 230, a third support portion 250, and a fourth support portion 260. Each support portion has an arm shape bent at a right angle along the A-axis and the B-axis. In the embodiment, the board structure 201 is formed of a quartz crystal board. The board structure 201 may be formed of a material other than quartz crystal.

The base portion 210 is coupled to the movable portion 214 via a groove-shaped joint portion 212 along the A-axis, thereby swingably supporting the movable portion 214. The base portion 210 has a U shape bent at a right angle in a plan view seen from the C-axis direction. The coupling portion 240 couples both ends of the U shape formed by the base portion 210. Accordingly, the base portion 210 and the coupling portion 240 form a substantial frame shape in the plan view. The first support portion 220 and the second support portion 230 are coupled to both sides of the base portion 210 in the A-axis direction. The third support portion 250 and the fourth support portion 260 are coupled to the base portion 210 at the vicinity of the coupling portion 240.

The joint portion 212 is provided between the base portion 210 and the movable portion 214 and couples the base portion 210 and the movable portion 214. The joint portion 212 is thinner than the base portion 210 and the movable portion 214. The joint portion 212 is formed in a constricted shape on both sides in the C-axis direction in a cross-sectional view seen from the A-axis direction. Therefore, the joint portion 212 that is thinner than the base portion 210 and the movable portion 214 functions as a fulcrum, that is, an intermediate hinge when the movable portion 214 is displaced with respect to the base portion 210.

The movable portion 214 is coupled to the base portion 210 via the joint portion 212. The movable portion 214 has a flat plate shape and has main surfaces 214a and 214b that face each other and that have a front and back relationship in the C-axis direction. The movable portion 214 is displaced in the C-axis direction with the joint portion 212 as a fulcrum according to an acceleration of a C-axis component. That is, the joint portion 212 and the movable portion 214 function as a cantilever.

The coupling portion 240 is disposed on a side of the movable portion 214 opposite to the joint portion 212 side, that is, in the B direction of the movable portion 214. The coupling portion 240 extends in the A-axis direction from one end portion of the base portion 210 where the third support portion 250 is provided to an end portion of the base portion 210 where the fourth support portion 260 is provided.

The first support portion 220 and the second support portion 230 are provided symmetrically with respect to a center line of the vibration element 270 along the B-axis in the plan view. In addition, similarly, the third support portion 250 and the fourth support portion 260 are provided symmetrically with respect to the center line of the vibration element 270 along the B-axis in the plan view. A distal end portion of each of the first support portion 220, the second support portion 230, the third support portion 250, and the fourth support portion 260 is coupled to an inner side of the package 310. Accordingly, the first support portion 220, the second support portion 230, the third support portion 250, and the fourth support portion 260 support the board structure 201 in the accommodation space 311 of the package 310.

Both ends of the vibration element 270 are coupled to the base portion 210 and the movable portion 214 of the board structure 201. In other words, the vibration element 270 is provided across the base portion 210 and the movable portion 214 to straddle the joint portion 212.

In the embodiment, the vibration element 270 is formed of a quartz crystal board. The vibration element 270 may be formed of a piezoelectric material other than quartz crystal. However, the vibration element 270 and the board structure 201 are preferably formed of the same material. Accordingly, since a difference between a linear expansion coefficient of the board structure 201 and a linear expansion coefficient of the vibration element 270 is small, it is possible to reduce a stress applied from the board structure 201 to the vibration element 270 caused by the difference in the linear expansion coefficient.

In the embodiment, the vibration element 270 is a double-tuning-fork type vibration element including two vibration beam portions 271a and 271b each along the B-axis, and a first base portion 272a and a second base portion 272b terminating both ends of each of the vibration beam portions 271a and 271b. The first base portion 272a is coupled to the movable portion 214. The second base portion 272b is coupled to the base portion 210 of the board structure 201. The vibration element 270 includes electrodes (not shown) provided on a surface thereof, for example, an excitation electrode and an extraction electrode. When a drive signal with an AC voltage is applied to the excitation electrode (not shown) provided on the vibration beam portions 271a and 271b, the vibration beam portions 271a and 271b perform flexural vibration in the A-axis direction so as to be separated from each other or approach each other.

Although the vibration element 270 is a double-tuning-fork type vibration element in the embodiment, the vibration element 270 is not limited to the double-tuning-fork type vibration element. For example, the vibration element 270 may be a single beam vibration element including one vibration beam portion.

The mass portions 280 and 282 are provided on the main surfaces 214a and 214b of the movable portion 214. Specifically, two mass portions 280 are provided on the main surface 214a via a bonding material (not shown). On the other hand, two mass portions 282 are provided on the main surface 214b via a bonding material (not shown). The mass portions 280 and 282 may be formed of a metal such as copper (Cu) or gold (Au).

In the sensor element 200 configured as described above, for example, when an acceleration in the C direction is applied, the movable portion 214 is displaced in the −C direction with the joint portion 212 as a fulcrum. Accordingly, a force in a direction in which the first base portion 272a and the second base portion 272b are separated from each other along the B-axis is applied to the vibration element 270, and a tensile stress is generated in the vibration beam portions 271a and 271b. Therefore, resonance frequencies of the vibration beam portions 271a and 271b increase. On the other hand, when an acceleration in the −C direction is applied to the sensor element 200, the movable portion 214 is displaced in the C direction with the joint portion 212 as a fulcrum. Accordingly, a force in a direction in which the first base portion 272a and the second base portion 272b approach each other along the B-axis is applied to the vibration element 270, and a compressive stress is generated in the vibration beam portions 271a and 271b. Therefore, the resonance frequencies of the vibration beam portions 271a and 271b decrease.

In this way, the sensor element 200 can detect an acceleration in the C-axis direction based on a resonance frequency of the vibration element 270. In other words, the sensor element 200 configured as described above is a frequency-variable type acceleration sensor element whose detection axis is the C-axis.

Next, the inertial sensor 300 using the above-described sensor element 200 will be described. As shown in FIG. 7, the inertial sensor 300 includes the sensor element 200 and the package 310. The package 310 includes a package base 320 and a lid 330.

The package base 320 has a box shape including a recessed portion 321 opened toward the C direction. The lid 330 has a flat plate shape. The lid 330 is coupled to the package base 320 via a lid bonding member 332 so as to close the opening of the recessed portion 321. By closing the opening of the recessed portion 321 by the lid 330, the accommodation space 311 in which the sensor element 200 is accommodated is formed. The accommodation space 311 is hermetically sealed.

The package base 320 includes a step portion 323 protruding from an inner bottom surface 322 of the package base 320 toward the lid 330. For example, the step portion 323 is provided in a frame shape along an inner wall of the package base 320. The step portion 323 is provided with a plurality of internal terminals 340b.

The plurality of internal terminals 340b are coupled to the first support portion 220, the second support portion 230, the third support portion 250, and the fourth support portion 260 of the sensor element 200. Specifically, each of the first support portion 220, the second support portion 230, the third support portion 250, and the fourth support portion 260 is provided with a fixing portion coupling terminal 79b. The fixing portion coupling terminal 79b and the internal terminal 340b are disposed to face each other so as to overlap each other in the plan view seen from the C-axis direction. The fixing portion coupling terminal 79b and the internal terminal 340b are electrically and mechanically coupled to each other via a conductive adhesive 343. In this way, the sensor element 200 is mounted to the package 310 in the accommodation space 311 of the package 310.

The package base 320 includes an external terminal 344 provided on an outer bottom surface 324. The external terminal 344 is electrically coupled to the internal terminal 340b via an internal wiring (not shown). In addition, for example, as shown in FIG. 5, when the inertial sensor 300 is disposed on the first surface 15f of the circuit board 15, the external terminal 344 is electrically coupled to a wiring (not shown) provided on the circuit board 15. The external terminal 344 may be provided not only on the outer bottom surface 324 but also on an outer wall of the package base 320.

In the inertial sensor 300 having such a configuration, when a drive signal is applied to an excitation electrode of the sensor element 200 via the external terminal 344, the internal terminal 340b, the fixing portion coupling terminal 79b, and the like, the vibration beam portions 271a and 271b of the sensor element 200 resonate at a predetermined frequency. Then, the inertial sensor 300 outputs, as an output signal, a resonance frequency of the sensor element 200 that changes according to an acceleration.

The inertial sensor 300 configured as described above is a frequency-variable type acceleration sensor whose detection axis is the C-axis. By matching the C-axis which is the detection axis of the inertial sensor 300 with a desired direction, the inertial sensor 300 can detect an acceleration in the desired direction.

For example, as shown in FIG. 5, when a side surface of the package 310 is opposite to the first surface 15f of the circuit board 15 and the inertial sensor 300 is vertically mounted on the circuit board 15 (upright mounting), the C-axis which is the detection axis of the inertial sensor 300 is along the first surface 15f of the circuit board 15.

Specifically, the first inertial sensor 301 is mounted such that the C-axis of the first inertial sensor 301, that is, the positive direction of the first detection axis H1 of the first inertial sensor 301 coincides with the Y direction in a state in which the first inertial sensor 301 is mounted upright on the first surface 15f of the circuit board 15. In addition, the second inertial sensor 302 is mounted such that the C-axis of the second inertial sensor 302, that is, the positive direction of the second detection axis H2 of the second inertial sensor 302 coincides with the −Y direction in a state in which the second inertial sensor 302 is mounted upright on the first surface 15f of the circuit board 15. In other words, the first inertial sensor 301 has the first detection axis H1 along the circuit board 15, and the second inertial sensor 302 has the second detection axis H2 defined in the direction opposite to the first detection axis H1.

In this way, by mounting the first inertial sensor 301 and the second inertial sensor 302 on the circuit board 15, the first inertial sensor 301 and the second inertial sensor 302 can detect an acceleration in the Y-axis direction. The detection value of the second inertial sensor 302 is in opposite phase to the detection value of the first inertial sensor 301.

In the embodiment, the first inertial sensor 301 and the second inertial sensor 302 have the same structure. However, structures of the first inertial sensor 301 and the second inertial sensor 302 may also be different from each other.

In addition, as described above, the first inertial sensor 301 and the second inertial sensor 302 are disposed on the first surface 15f of the circuit board 15. That is, the first inertial sensor 301 and the second inertial sensor 302 are disposed on one surface of the circuit board 15. The expression “disposed on one surface of the circuit board 15” means that the components are disposed on the same surface of the circuit board 15. Although the first inertial sensor 301 and the second inertial sensor 302 are disposed on the first surface 15f in the embodiment, the first inertial sensor 301 and the second inertial sensor 302 may also be disposed on the second surface 15r.

In this way, by disposing the first inertial sensor 301 and the second inertial sensor 302 on the one surface of the circuit board 15, the stress from the circuit board 15 is generated from the same direction (direction orthogonal to the detection axis) in the first inertial sensor 301 and the second inertial sensor 302. For example, when a compressive stress from the circuit board 15 is applied to the first inertial sensor 301 since the circuit board 15 is wrapped due to thermal expansion of the circuit board 15 or an external force, a compressive stress from the circuit board 15 is also applied to the second inertial sensor 302. That is, noises caused by the stress from the circuit board 15 are in-phase error factors. Therefore, by generating the differential signal which is the difference between the output signal of the first inertial sensor 301 and the output signal of the second inertial sensor 302, it is possible to cancel out the noise caused by the stress from the circuit board 15. Therefore, accuracy of an acceleration measurement value output from the inertial measurement device 100 is improved.

In addition, as described above, the first inertial sensor 301 and the second inertial sensor 302 are mounted upright on the first surface 15f of the circuit board 15. Accordingly, a mounting region in which the first inertial sensor 301 and the second inertial sensor 302 are mounted is reduced as compared with a case where a bottom surface of the package 310 faces the first surface 15f of the circuit board 15 and the inertial sensor 300 is mounted horizontally on the circuit board 15 (horizontal mounting). Therefore, the noise caused by the stress from the circuit board 15 can be reduced, and the accuracy of the acceleration measurement value output from the inertial measurement device 100 is improved.

In addition, as described above, the C-axis which is the detection axis of the first inertial sensor 301 and the second inertial sensor 302 is the direction along the first surface 15f of the circuit board 15. When the Z direction which is a normal direction of the second surface 15r is along a gravity direction and the inertial measurement device 100 is in a stationary state, detection signals of the first inertial sensor 301 and the second inertial sensor 302 are in a state in which an acceleration is zero, that is, are signals corresponding to an origin. However, in general, an acceleration sensor such as the inertial sensor 300 may cause so-called origin drift during which a position of the origin moves.

As described above, in the embodiment, the differential signal which is the difference between the output signal of the first inertial sensor 301 and the output signal of the second inertial sensor 302 is generated. Origin drifts in the detection signals of the first inertial sensor 301 and the second inertial sensor 302 are canceled out by generating the differential signal when the origin drifts are in-phase error factors. Therefore, an origin drift of the acceleration measurement value output from the inertial measurement device 100 is reduced, and origin stability is improved. In this way, since a measurement value with high origin stability is obtained, the inertial measurement device 100 can also be suitably used, for example, as an inclination sensor.

In the embodiment, the inertial measurement device 100 measures an acceleration in the Y-axis direction. However, the physical quantity measured by the inertial measurement device 100 is not limited thereto. For example, the inertial measurement device 100 may measure an acceleration in the X-axis direction. For example, by disposing the first inertial sensor 301 on the circuit board 15 such that the first detection axis H1 coincides with the X direction and disposing the second inertial sensor 302 on the circuit board 15 such that the second detection axis H2 coincides with the −X direction, the inertial measurement device 100 can measure the acceleration in the X-axis direction with high accuracy.

The stress applied from the circuit board 15 to the inertial sensor 300 tends to increase as the inertial sensor 300 approaches a fixing point where the circuit board 15 and the container 1 are coupled to each other. The fixing point where the circuit board 15 and the container 1 are coupled to each other means a region where the circuit board 15 is mechanically coupled to the container 1.

As described above, the circuit board 15 is supported in the container 1 on the first pedestal 27 and the second pedestals 25 and 26 provided in the container 1. More specifically, as shown in FIGS. 3, 4, and 5, the circuit board 15 is mechanically coupled to the first pedestal 27 via the fixing member 42 disposed in a ring shape around the connector 16 and is mechanically coupled to the second pedestals 25 and 26 via the fixing member 30. That is, in the embodiment, the fixing point where the circuit board 15 and the container 1 are coupled to each other is a coupling region between the circuit board 15 and the fixing member 42 and a coupling region between the circuit board 15 and the fixing member 30.

In the embodiment, the fixing point of the circuit board 15 is located on an outer side of the first inertial sensor 301, the second inertial sensor 302, and a region interposed between the first inertial sensor 301 and the second inertial sensor 302 in the plan view. Further, the fixing point of the circuit board 15 is located on an outer edge portion of the circuit board 15 in the plan view. By disposing the fixing point of the circuit board 15 in this way, the stress from the circuit board 15 applied to the first inertial sensor 301 and the second inertial sensor 302 is reduced. Therefore, the noise caused by the stress from the circuit board 15 can be reduced, and the accuracy of the acceleration measurement value output from the inertial measurement device 100 is improved.

In the embodiment, the fixing member 30 and the fixing member 42 are adhesives. However, the method of mechanically coupling the circuit board 15 and the container 1 is not limited to bonding. As a method of mechanically coupling the circuit board 15 and the container 1, a well-known method such as fastening or fitting can be used in addition to bonding.

As described above, according to the embodiment, the following effects can be obtained. The inertial measurement device 100 includes the first inertial sensor 301 disposed on the first surface 15f of the circuit board 15 as a board and having the first detection axis H1 along the circuit board 15, the second inertial sensor 302 disposed on the first surface 15f and having the second detection axis H2 defined in the direction opposite to the first detection axis H1, and the processing circuit 19 configured to generate the differential signal between the output signal of the first inertial sensor 301 and the output signal of the second inertial sensor 302. Accordingly, the noise caused by the stress from the circuit board 15 can be canceled out, and the accuracy of the acceleration measurement value as the physical quantity output from the inertial measurement device 100 is improved.

### 2. Second Embodiment

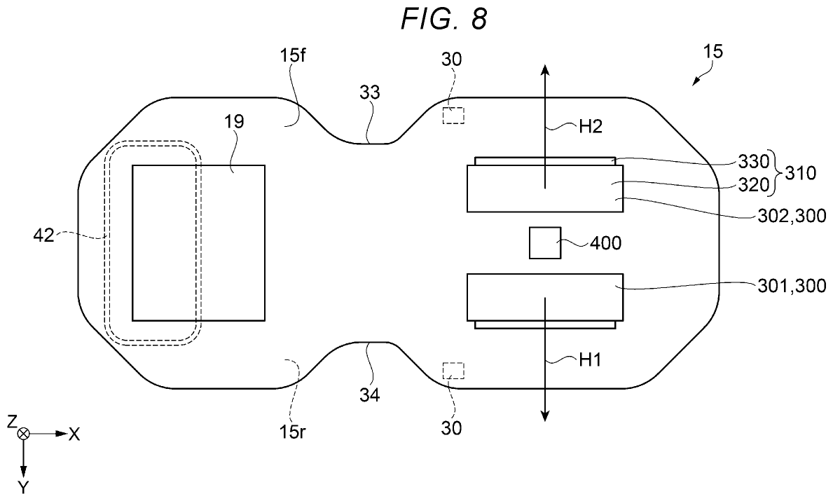

Next, the inertial measurement device 100 according to a second embodiment will be described with reference to FIG. 8. The inertial measurement device 100 according to the second embodiment is the same as that of the first embodiment except that a temperature sensor 400 is provided. The same components as those in the first embodiment are denoted by the same reference numerals, and description thereof is omitted. Other configurations, functions, and effects not described in the second embodiment are the same as those of the first embodiment.

As shown in FIG. 8, in addition to the first inertial sensor 301, the second inertial sensor 302, and the processing circuit 19, the temperature sensor 400 is further disposed on the first surface 15f of the circuit board 15 provided in the inertial measurement device 100 according to the embodiment.

The temperature sensor 400 is electrically coupled to the processing circuit 19 via a wiring (not shown) or the like provided on the circuit board 15. The temperature sensor 400 is disposed in the vicinity of the first inertial sensor 301 and the second inertial sensor 302. In the embodiment, the temperature sensor 400 is disposed in a region interposed between the first inertial sensor 301 and the second inertial sensor 302 in the plan view so as to detect a temperature between the first inertial sensor 301 and the second inertial sensor 302.

The processing circuit 19 corrects a temperature characteristic of a differential signal between an output signal of the first inertial sensor 301 and an output signal of the second inertial sensor 302 by using the temperature detected by the temperature sensor 400.

A temperature characteristic of the first inertial sensor 301 and a temperature characteristic of the second inertial sensor 302 are not the same due to manufacturing variations in the inertial sensor 300 and the like, and thus a difference occurs therebetween. Therefore, the differential signal between the output signal of the first inertial sensor 301 and the output signal of the second inertial sensor 302 has a temperature characteristic corresponding to the temperature characteristic difference between the first inertial sensor 301 and the second inertial sensor 302.

In the embodiment, since the temperature characteristic of the differential signal between the output signal of the first inertial sensor 301 and the output signal of the second inertial sensor 302 is corrected by using the temperature detected by the temperature sensor 400, accuracy of an acceleration measurement value output from the inertial measurement device 100 is improved.

In the embodiment, the temperature sensor 400 is disposed in the region interposed between the first inertial sensor 301 and the second inertial sensor 302 in the plan view, but the disposition of the temperature sensor 400 is not limited thereto. For example, the temperature sensor 400 may be disposed at equal distances from the first inertial sensor 301 and the second inertial sensor 302. By disposing the temperature sensor 400 in this way, it is still possible to detect the temperature between the first inertial sensor 301 and the second inertial sensor 302.

According to the embodiment, the following effects can be obtained in addition to the effects in the first embodiment. Since the temperature characteristic of the differential signal between the output signal of the first inertial sensor 301 and the output signal of the second inertial sensor 302 is corrected by using the temperature detected by the temperature sensor 400, the accuracy of the acceleration measurement value output from the inertial measurement device 100 is improved.

### 3. Third Embodiment

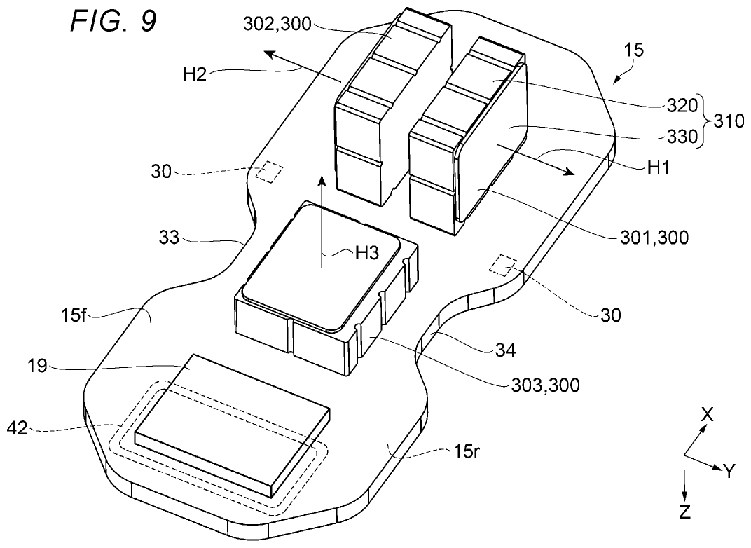

Next, the inertial measurement device 100 according to a third embodiment will be described with reference to FIG. 9. The inertial measurement device 100 according to the third embodiment is the same as that of the first embodiment except that a third inertial sensor 303 is provided. That is, the inertial measurement device 100 according to the embodiment further includes the third inertial sensor 303 in addition to the first inertial sensor 301 and the second inertial sensor 302. As will be described later, the third inertial sensor 303 is an acceleration sensor that detects an acceleration in the Z-axis direction. Accordingly, the inertial measurement device 100 according to the embodiment can measure the acceleration in the Z-axis direction in addition to the acceleration in the Y-axis direction. The same components as those in the first embodiment are denoted by the same reference numerals, and description thereof is omitted. Other configurations, functions, and effects not described in the third embodiment are the same as those in the first embodiment.

As shown in FIG. 9, three inertial sensors 300 and the processing circuit 19 are disposed on the first surface 15f of the circuit board 15 provided in the inertial measurement device 100 according to the embodiment. The three inertial sensors 300 are the first inertial sensor 301, the second inertial sensor 302, and the third inertial sensor 303. That is, in the embodiment, the third inertial sensor 303 is further disposed on the first surface 15f of the circuit board 15 in addition to the first inertial sensor 301, the second inertial sensor 302, and the processing circuit 19. Although the third inertial sensor 303 is disposed on the first surface 15f of the circuit board 15 in the embodiment, the third inertial sensor 303 may be disposed on the second surface 15r.

The third inertial sensor 303 is electrically coupled to the processing circuit 19 and the connector 16 via a wiring (not shown) provided on the circuit board 15. A structure of the third inertial sensor 303 is the same as a structure of each of the first inertial sensor 301 and the second inertial sensor 302. The structure of the third inertial sensor 303 may also be different from the structure of each of the first inertial sensor 301 and the second inertial sensor 302.

The third inertial sensor 303 detects an acceleration on a third detection axis H3. In the embodiment, the third inertial sensor 303 is horizontally mounted on the first surface 15f of the circuit board 15. That is, the third inertial sensor 303 is mounted such that the C-axis of the third inertial sensor 303, that is, the third detection axis H3 of the third inertial sensor 303 is along the Z-axis direction that is a direction orthogonal to the circuit board 15. In other words, the third inertial sensor 303 has the third detection axis H3 along a normal line of the circuit board 15. Specifically, the third detection axis H3 of the third inertial sensor 303 is a detection axis whose positive direction is the −Z direction. More specifically, the third detection axis H3 is a detection axis whose negative direction is the Z direction and whose positive direction is the −Z direction.

By mounting the third inertial sensor 303 in this way, the third inertial sensor 303 detects the acceleration in the Z-axis direction. That is, the inertial measurement device 100 can measure the acceleration in the Z-axis direction by using the third inertial sensor 303.

In addition to the third inertial sensor 303, the inertial measurement device 100 may further include an inertial sensor 300 having a detection axis defined in a direction opposite to the third detection axis H3. Accordingly, a differential signal between an output signal of the third inertial sensor 303 and an output signal of the inertial sensor 300 having the detection axis defined in the direction opposite to the third detection axis H3 can be generated by the processing circuit 19. That is, the differential signal can be generated for the acceleration in the Z-axis direction. In the differential signal between the output signal of the third inertial sensor 303 and the output signal of the inertial sensor 300 having the detection axis defined in the direction opposite to the third detection axis H3, an origin drift is reduced as compared with the output signal of the third inertial sensor 303, and thus origin stability and accuracy of a measurement value are improved.

Even when the inertial sensor 300 having the detection axis defined in the direction opposite to the third detection axis H3 is not used and the differential signal is not generated, the third inertial sensor 303 can be suitably used as a sensor for an application where high origin stability is not relatively required, for example, a vibration sensor that measures vibration.

According to the embodiment, the following effects can be obtained in addition to the effects in the first embodiment. Since the inertial measurement device 100 further includes the third inertial sensor 303 having the third detection axis H3 along the normal line of the circuit board 15, the acceleration in the Z-axis direction can be measured as the physical quantity along the normal line of the circuit board 15 in addition to the acceleration in the Y-axis direction as the physical quantity along the circuit board 15. That is, in the embodiment, it is possible to provide the inertial measurement device 100 that detects the physical quantity in directions along two axes.

### 4. Fourth Embodiment

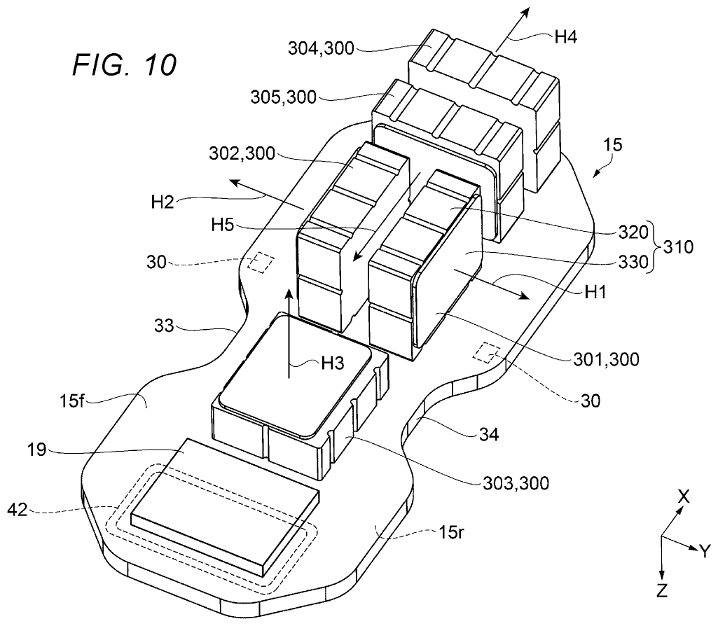

Next, the inertial measurement device 100 according to a fourth embodiment will be described with reference to FIG. 10. The inertial measurement device 100 according to the fourth embodiment is the same as that of the third embodiment except that a fourth inertial sensor 304 and a fifth inertial sensor 305 are provided. That is, the inertial measurement device 100 according to the embodiment further includes the fourth inertial sensor 304 and the fifth inertial sensor 305 in addition to the first inertial sensor 301, the second inertial sensor 302, and the third inertial sensor 303. As will be described later, the fourth inertial sensor 304 and the fifth inertial sensor 305 are acceleration sensors that detect an acceleration in the X-axis direction. Accordingly, the inertial measurement device 100 according to the embodiment can measure the acceleration in the X-axis direction in addition to the acceleration in the Y-axis direction and the acceleration in the Z-axis direction. The same components as those in the third embodiment are denoted by the same reference numerals, and description thereof is omitted. Other configurations, functions, and effects not described in the fourth embodiment are the same as those in the third embodiment.

As shown in FIG. 10, five inertial sensors 300 and the processing circuit 19 are disposed on the first surface 15f of the circuit board 15 provided in the inertial measurement device 100 according to the embodiment. The five inertial sensors 300 are the first inertial sensor 301, the second inertial sensor 302, the third inertial sensor 303, the fourth inertial sensor 304, and the fifth inertial sensor 305. That is, in the embodiment, the fourth inertial sensor 304 and the fifth inertial sensor 305 are further disposed on the first surface 15f of the circuit board 15 in addition to the first inertial sensor 301, the second inertial sensor 302, the third inertial sensor 303, and the processing circuit 19. Although the fourth inertial sensor 304 and the fifth inertial sensor 305 are disposed on the first surface 15f of the circuit board 15 in the embodiment, the fourth inertial sensor 304 and the fifth inertial sensor 305 may be disposed on the second surface 15r.

The fourth inertial sensor 304 and the fifth inertial sensor 305 are electrically coupled to the processing circuit 19 and the connector 16 via a wiring (not shown) provided on the circuit board 15.

The fourth inertial sensor 304 and the fifth inertial sensor 305 have the same structure as those of the first inertial sensor 301, the second inertial sensor 302, and the third inertial sensor 303. The structure of each of the fourth inertial sensor 304 and the fifth inertial sensor 305 may also be different from the structure of each of the first inertial sensor 301, the second inertial sensor 302, and the third inertial sensor 303.

The fourth inertial sensor 304 detects an acceleration on a fourth detection axis H4. The fifth inertial sensor 305 detects an acceleration on a fifth detection axis H5.

The fourth inertial sensor 304 is the same as the first inertial sensor 301 except that the fourth inertial sensor 304 is mounted in a posture rotated counterclockwise by 90 degrees with respect to the first inertial sensor 301 in the plan view. The fifth inertial sensor 305 is the same as the second inertial sensor 302 except that the fifth inertial sensor 305 is mounted in a posture rotated counterclockwise by 90 degrees with respect to the second inertial sensor 302 in the plan view.

Specifically, the fourth inertial sensor 304 is mounted such that the C-axis of the fourth inertial sensor 304, that is, the fourth detection axis H4 of the fourth inertial sensor 304 coincides with the X direction in a state in which the fourth inertial sensor 304 is mounted upright on the first surface 15f of the circuit board 15. In addition, the fifth inertial sensor 305 is mounted such that the C-axis of the fifth inertial sensor 305, that is, the fifth detection axis H5 of the fifth inertial sensor 305 coincides with the −X direction in a state in which the fifth inertial sensor 305 is mounted upright on the first surface 15f of the circuit board 15. Specifically, the fourth detection axis H4 of the fourth inertial sensor 304 is a detection axis whose positive direction is the X direction and whose negative direction is the −X direction. The fifth detection axis H5 of the fifth inertial sensor 305 is a detection axis defined in a direction opposite to the fourth detection axis H4, a positive direction thereof is the −X direction and a negative direction thereof is the X direction.

In this way, by mounting the fourth inertial sensor 304 and the fifth inertial sensor 305 on the circuit board 15, the fourth inertial sensor 304 and the fifth inertial sensor 305 can detect the acceleration in the X-axis direction. A detection value of the fifth inertial sensor 305 is in opposite phase to a detection value of the fourth inertial sensor 304.

In addition, in the embodiment, the processing circuit 19 generates, based on an output signal as the detection value of the fourth inertial sensor 304 and an output signal as the detection value of the fifth inertial sensor 305, a differential signal as a differential value that is a difference between the detection value of the fourth inertial sensor 304 and the detection value of the fifth inertial sensor 305. The differential signal generated by the processing circuit 19 is output to an external device coupled to the inertial measurement device 100 via the connector 16. In the embodiment, the differential signal output from the inertial measurement device 100 corresponds to a measurement value of an acceleration in the X-axis direction measured by the inertial measurement device 100.

According to the embodiment, the following effects can be obtained in addition to the effects in the third embodiment. Since the fourth inertial sensor 304 having the fourth detection axis H4 and the fifth inertial sensor 305 having the fifth detection axis H5 are further provided, the inertial measurement device 100 can measure the acceleration in the X-axis direction in addition to the acceleration in the Y-axis direction and the acceleration in the Z-axis direction. That is, in the embodiment, it is possible to provide the inertial measurement device 100 that detects the physical quantity in three axial directions.

In addition, as described above, since the processing circuit 19 generates the differential signal that is the difference between the output signal of the fourth inertial sensor 304 and the output signal of the fifth inertial sensor 305 in the embodiment, accuracy of the measurement value and origin stability are also improved for the measurement value of the acceleration in the X-axis direction. Therefore, the inertial measurement device 100 according to the embodiment can be more suitably used as a biaxial inclination sensor.

The inertial measurement device 100 has been described above based on the first embodiment to the fourth embodiment. However, the present disclosure is not limited thereto, and the configuration of each unit can be replaced with any configuration having the same function. In addition, any other components may be added to the present disclosure. In addition, the embodiments may be appropriately combined.

What is claimed is:

1. An inertial measurement device comprising:
a board;
a first inertial sensor disposed on one surface of the board and having a first detection axis along the board;
a second inertial sensor disposed on the one surface and having a second detection axis defined in a direction opposite to the first detection axis; and
a processing circuit configured to generate a differential signal between an output signal of the first inertial sensor and an output signal of the second inertial sensor.

2. The inertial measurement device according to claim 1, further comprising:
a temperature sensor configured to detect a temperature between the first inertial sensor and the second inertial sensor, wherein
the processing circuit corrects a temperature characteristic of the differential signal by using the temperature.

3. The inertial measurement device according to claim 1, further comprising:
a third inertial sensor disposed on the board and having a third detection axis along a normal line of the board.

4. The inertial measurement device according to claim 1, wherein
a fixing point of the board is located on an outer side of the first inertial sensor, the second inertial sensor, and a region interposed between the first inertial sensor and the second inertial sensor in a plan view.

5. The inertial measurement device according to claim 1, wherein
each of the first inertial sensor and the second inertial sensor is a frequency-variable type acceleration sensor.
